(19) United States
(12) Patent Application Publication
(10) Pub. No.: US 2015/0333302 A1
(43) Pub. Date: Nov. 19, 2015

(54) FLEXIBLE BAND OR STRAP WITH INTEGRATED BATTERY

(71) Applicant: Pebble Technology Corp., Palo Alto, CA (US)

(72) Inventors: Steven Johns, Vancouver (CA); Mark Solomon, San Jose, CA (US)

(21) Appl. No.: 14/713,536

(22) Filed: May 15, 2015

Related U.S. Application Data
(60) Provisional application No. 61/993,795, filed on May 15, 2014.

(51) Int. Cl. H01M 2/10; H01M 2/02

(52) U.S. Cl. CPC H01M 2/1066; H01M 2/0275; H01M 2220/30

(57) ABSTRACT

A method, apparatus, and system relating to a strap or band with an integrated battery are disclosed. The band or strap is designed to retain some flexibility and to interface with an electronic user device (e.g., smart watch, smartphone, etc.).

### BACKGROUND OF THE INVENTION

1. Field of the Invention

The invention relates generally to a method, system, and apparatus for a flexible band with an integrated battery that is configured to interface with a user device, such as a smartwatch and the like. The disclosed invention is particularly advantageous, because it allows for, among other things, additional battery life, space conservation and comfort.

2. Description of the Related Art

User communication devices, such as smartphones and smartwatches, allow users to interact and communicate with users of other communication devices. Smartphones are generally much larger than smartwatches and are expected by users to be carried in their pocket, purse, or the like. Wearable user devices, on the other hand, are expected by users to be smaller and comfortably worn. Moreover, because wearable user devices are expected to be worn as an accessory, users desire more stylish, sleek, and compact seeming wearable devices.

A substantial component of any smartwatch is the battery that powers the device. Generally, very large batteries are used to power smartphones because smartphones have a substantial number of features, such as large memory, powerful processors, and a high quality liquid-crystal display (LCD) display. As previously discussed, because smartphones are not expected to be worn by their users, the phones can be designed to include much larger batteries to power those features for days at a time. In stark contrast, several of the features that are typically found in a smartphone are generally sacrificed in a smartwatch because of the expectations of the user discussed above. Due to some of these design sacrifices, a much smaller and less powerful battery is capable of powering the more limited features of a smartwatch. However, current smartwatches are generally assembled with the battery embedded into the housing of the smartwatch unit itself. For example, U.S. Publication No. 2009/0069045 discloses such a smartwatch. As shown in FIG. 1, which is a reproduction of FIG. 3 of that publication, element 117 is the battery, which is rather large and embedded into the housing of the smartwatch circuitry itself. Because the battery is embedded into the smartwatch circuitry, the smartwatch housing is larger, which runs contrary to the style, size, and comfort expectations of the wearers of the device. Moreover, the large battery reduces the space for other components that may be used for additional features, such as additional memory or a high quality LCD display.

In one prior art watch (which is not a smartwatch), known as the CST-01, the watch battery is embedded into the band of the watch. The battery is a micro energy cell created by Thinergy. However, the watch and band all comprise a single piece of flexible stainless steel which only allows for relatively small bend radius. There are at least three draw backs to the CST-01. First, the watch may be uncomfortable to the user, as it is a single piece of steel (i.e., a hard outer material) that is wrapped around the user's wrist and allows for a minimal bend radius. Second, the watch does not allow the user to change out the bands because the watch face circuitry is not configured to be removed from the band. Third, the watch does not utilize much of the free space in the length of the steel band for additional battery circuitry, which could significantly increase the battery life of the watch on each individual charge. The battery is a small square or rectangle that is embedded near the watch itself, and as such, is not integral or contiguous with the band. The battery is thus non flexible and cannot conform to the wearers wrists. Furthermore this battery capacity is insufficient to provide enough lasting power for watches such as the Pebble smartwatch.

Thus, the need exists in the field of wearable user devices for a flexible band containing a battery that improves the comfort level of the user. The need further exists for a strap or band containing a battery that utilizes band space to increase battery capacity, and as such increase the battery life of the corresponding user device. This need is especially great in the field of wearable smartwatches, where space efficiency and conservation, battery life, style, and comfort are all desirable features to wearers.

### SUMMARY OF THE INVENTION

Implementations of the presently disclosed technology relate to a strap or band that may freely bend, wherein the strap or band contains a battery. This implementation can be used with any wearable technology.

### BRIEF DESCRIPTION OF THE FIGURES

The accompanying drawings, which are incorporated in and constitute a part of this specification, illustrate an implementation of apparatuses and methods consistent with the present invention and, together with the detailed description, serve to explain advantages and principles consistent with the invention.

FIG. 1 is a prior art watch from U.S. Publication No. 2009/0069045, wherein the battery of the watch is integrated into the housing of the watch circuitry.

FIGS. 2(a)-(d) illustrate different views of an assembly of a flexible band or strap containing a battery, wherein the battery is secured to spring steel structure or frame.

FIG. 3 is a flow chart for one exemplary method of assembling the flexible band or strap from FIGS. 2(a)-(d).

FIGS. 4(a)-(d) illustrate different views of an assembly of a flexible band or strap containing a battery, wherein the battery is secured to an injection molded sub structure.

FIG. 5 is a flow chart for one exemplary method of assembling the flexible band or strap from FIGS. 4(a)-(d).

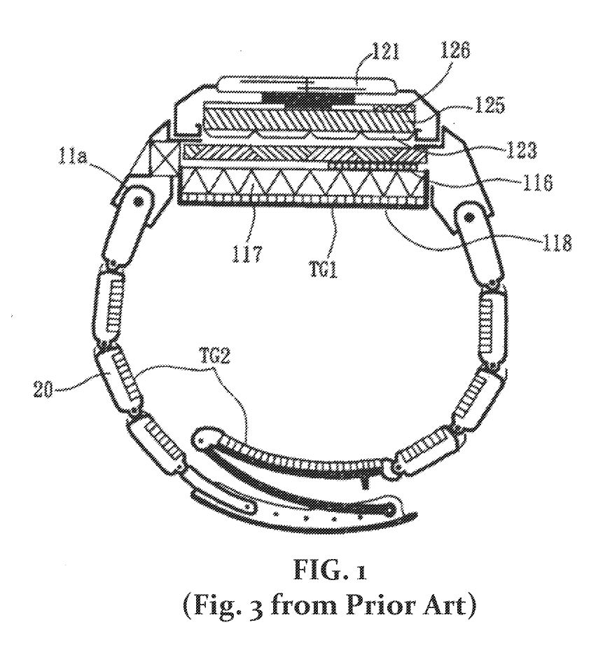

### DETAILED DESCRIPTION OF THE PREFERRED EMBODIMENTS

The present invention is directed to an improved method, apparatus and system, for manufacturing a flexible band or strap containing a battery. The following description stresses the use of the invention with smartwatches, but is useful for any wearable user device. An important feature of the disclosed apparatus is that the band or strap remains flexible.

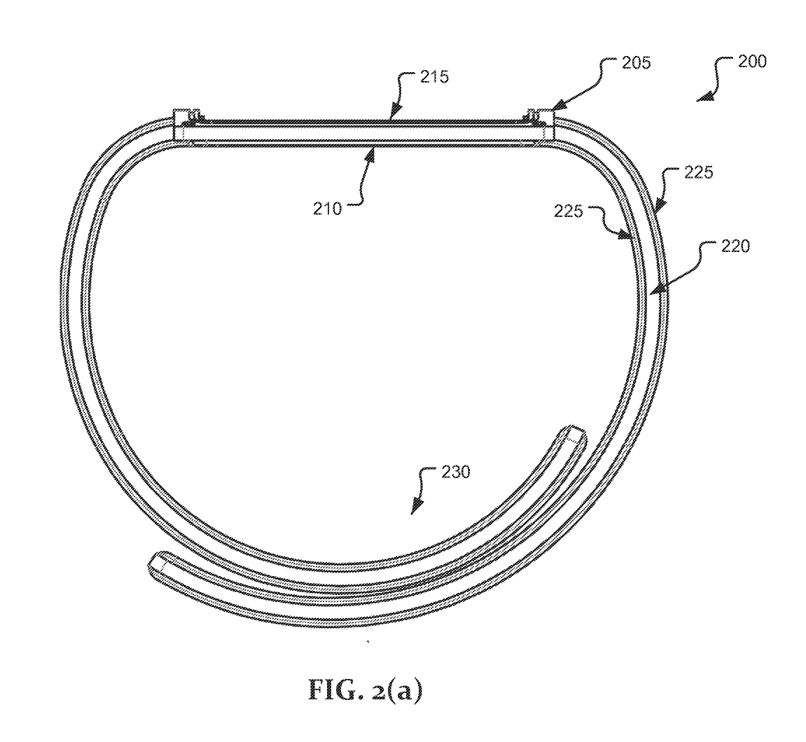

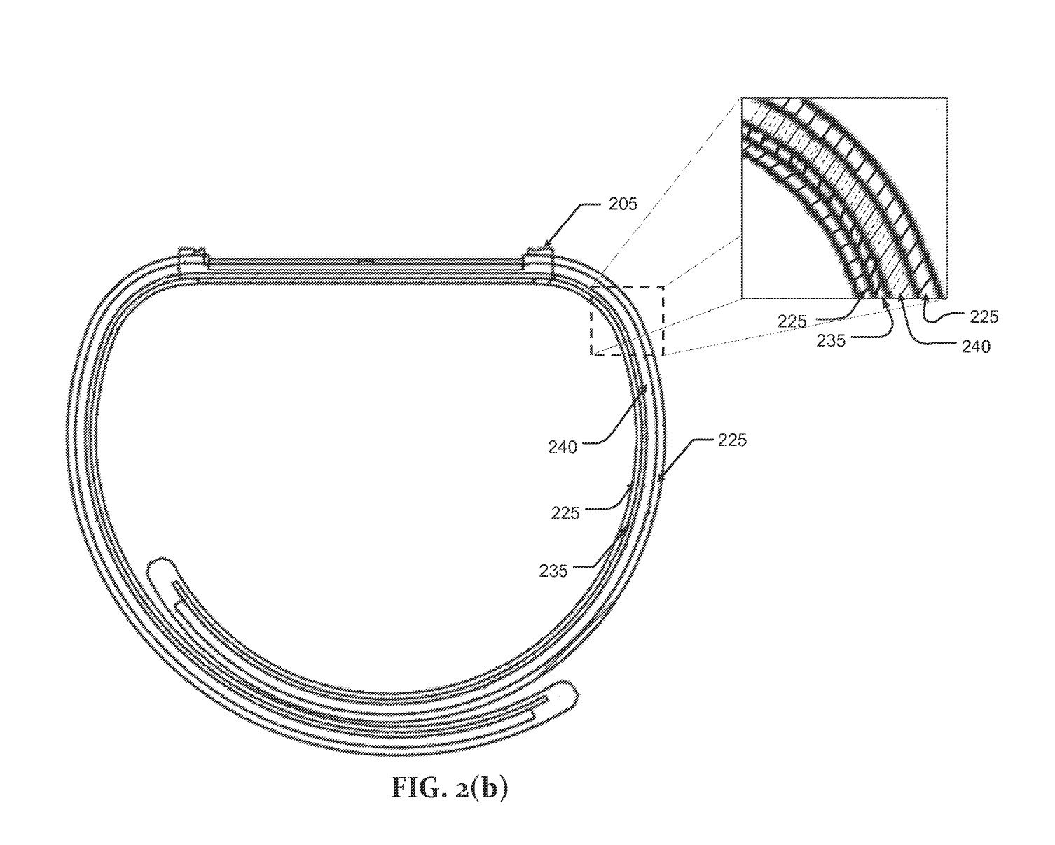

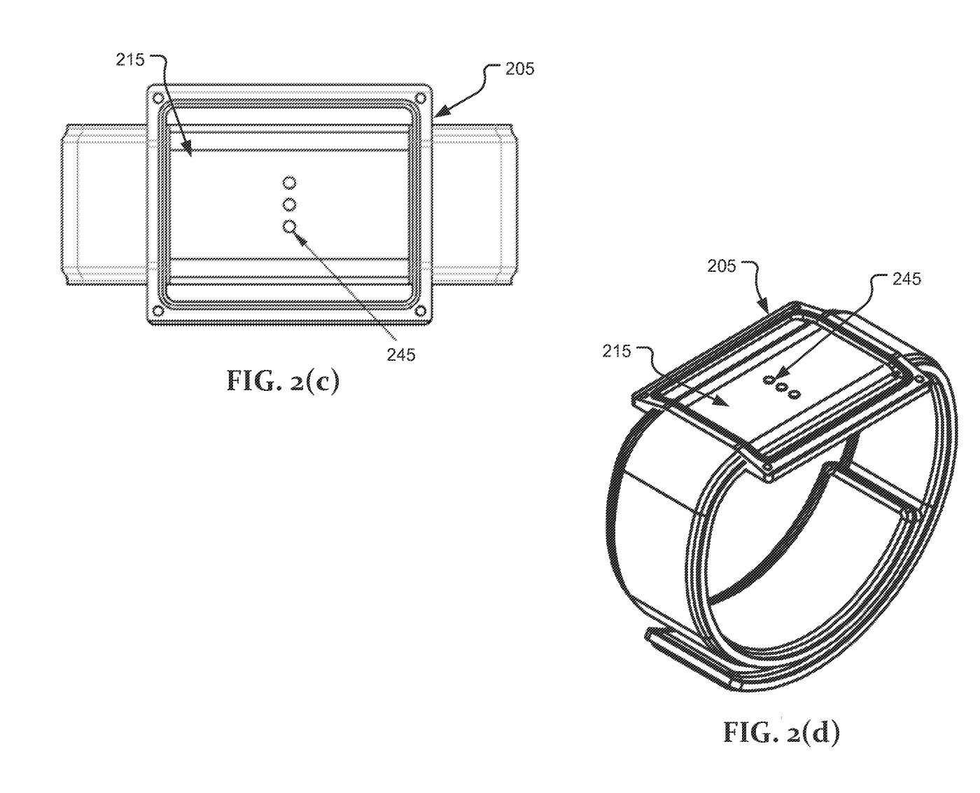

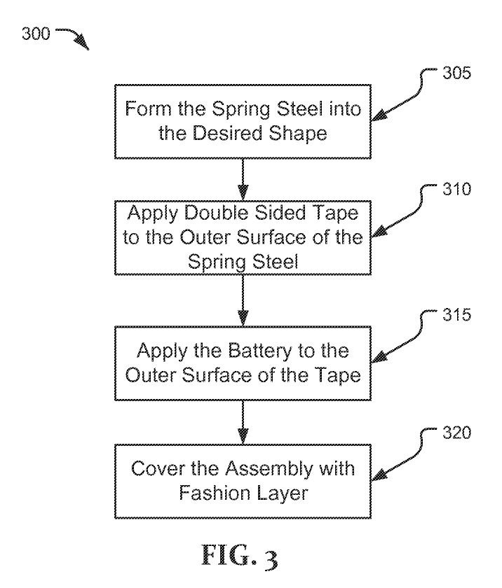

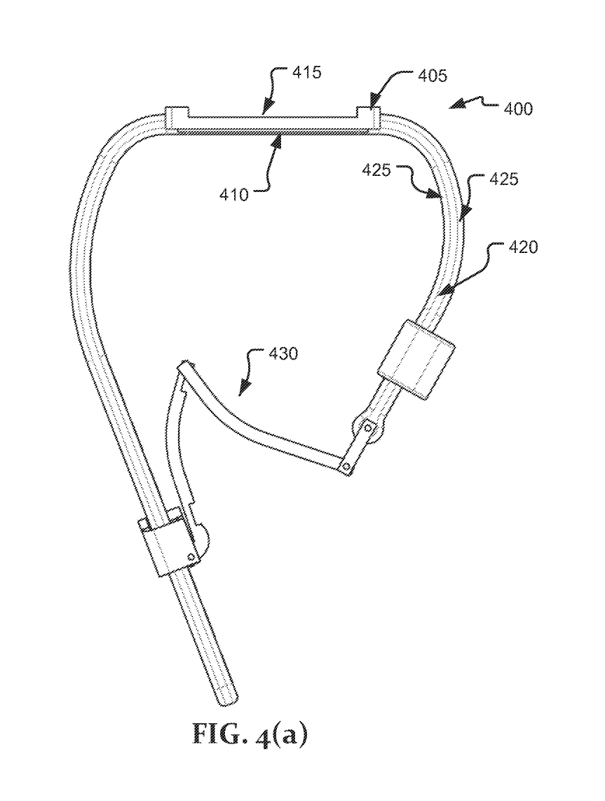

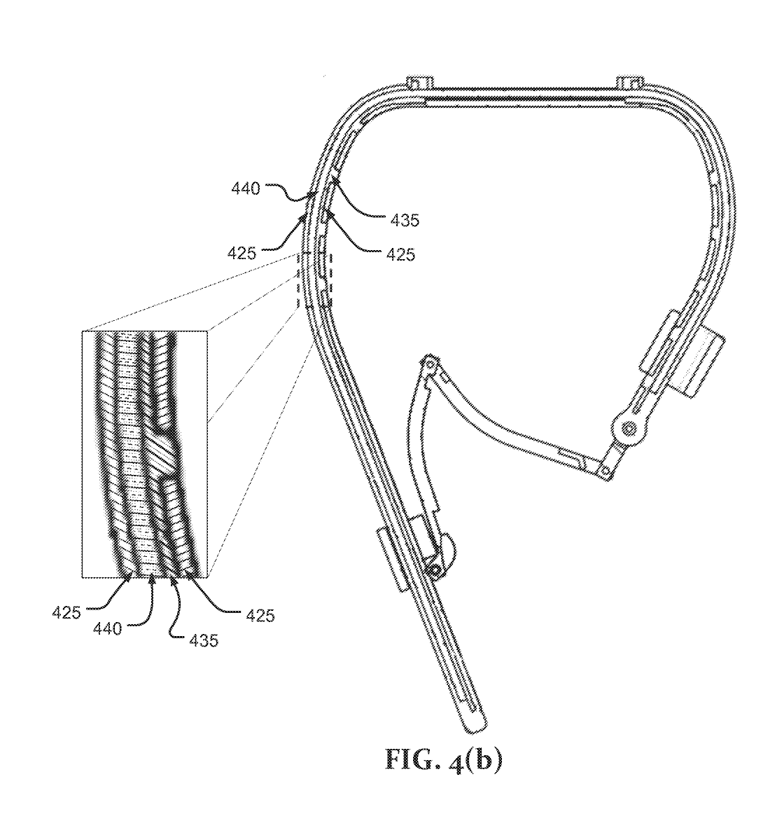

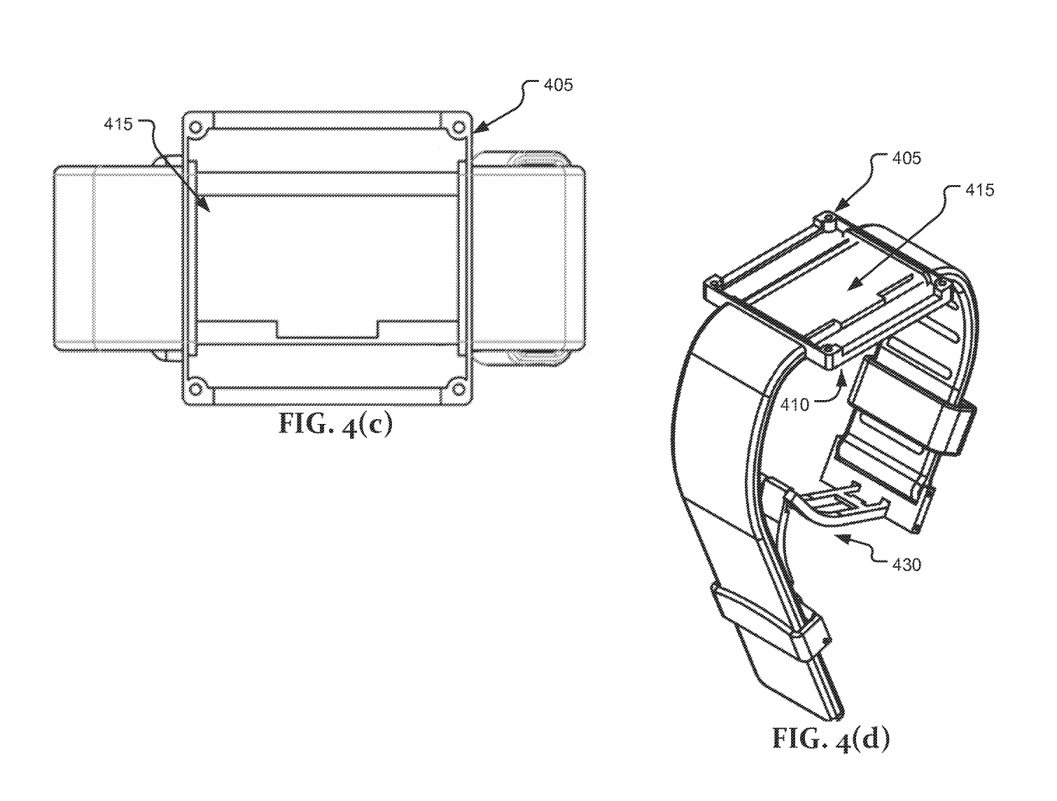

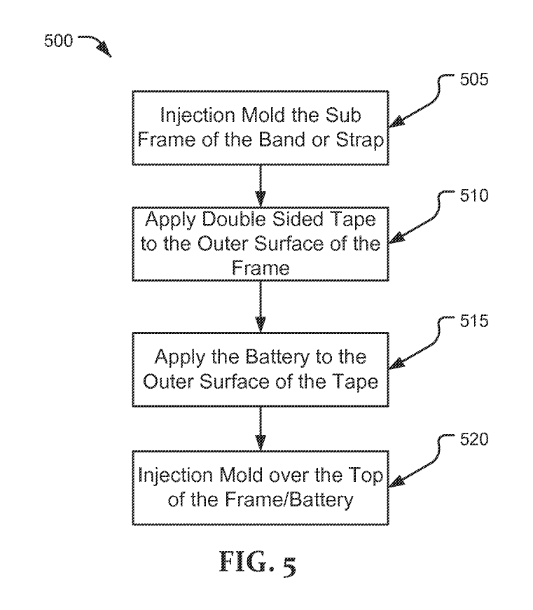

With this in mind, the following description begins with an exemplary strap or band with reference to FIGS. 2(a)-(d), which implements components such as a battery secured to spring steel frame or structure. The description continues with the block diagram illustrated in FIG. 3, which illustrates the general assembly and manufacturing steps for the strap or band from FIGS. 2(a)-(d). Next follows a discussion of a second exemplary strap or band with reference to FIGS. 4(a)-(d), which includes a battery that is secured to an injection molded sub structure. The description continues with the block diagram illustrated in FIG. 5, which illustrates the general assembly and manufacturing steps for the strap or band from FIGS. 4(a)-(d).

Turning now to FIG. 2(a), an exemplary strap or band 200 is shown, which is comprised of a spring steel frame secured to a battery. The strap or band 200 is secured to a dock 205 configured in this embodiment for a watch. The dock 205 may be made of a plastic (e.g., Polycarbonate or Polycarbonate/Acrylonitrile Butadiene Styrene), metal (e.g., steel, or aluminum) or any other material durable enough to sufficiently secure, maintain, and protect the integrity of the external watch circuitry (not shown). While the present embodiment is directed towards a smart watch, it would be understood by those of ordinary skill in that the present invention could be utilized with other kinds of wearable user devices. The top surface 215 of the dock 205 is designed to interface with the external docked device's circuitry (e.g., the watch face, processor, memory, etc.). As will be discussed with regard to FIGS. 2(c)-(d), this may be accomplished by including interface pins on the top surface 215 of the dock 205. A user may then insert the external circuitry into the dock 205 by snapping the external circuitry housing in place so that the pins on the top surface 215 engage with an interface on the bottom of the external watch circuitry. Pogo pins may be particularly advantageous as they allow for interchangeability with new straps. For example if the wearer wanted to change strap colors, textures, or needed a replacement. Additionally, the band 200 may include a charging connection or interface on the bottom or back of the dock 210. This may allow the battery in the band 200 to be charged even when the external circuitry is not interfaced with the dock 205. If the charging connection or interface is on the back of the dock 210, the band 200 could be charged even when the external device is coupled to the dock 205. Alternatively, the external circuitry may include a charging connection to allow the battery of the band 200 to be charged via the external circuitry when the external circuitry is secured in the dock 210.

The strap or band 200 is comprised of an outer surface or fashion layer 225, which may be leather or another material, to meet a user's fashion desires. Alternatively, the fashion layer 225 could be made of a harder material, such as steel. The steel could be, for example, segmented or chain-linked, which may be more visually appealing to the wearer. Interposed between the outer layer 225 is a layer 220 comprising a battery layer secured to spring steel layer using an adhesive (e.g., double-sided tape) or by a mechanical fastener like a spring bar or cotter pin. As will be appreciated by those having ordinary skill in the art, spring steel is particularly advantageous in that it has a memory to its form and is easy to flex. Consequently, it remains flexible while always returning back to its original form. This allows for more flexibility as compared to other current watch bands containing a battery. The strap or band 200 also contains a fastener 230, which allows for the wearer of the strap or band 200 to close it around his or her wrist. The fastener 230 illustrated is clasp-less, because it is able to fasten the watch to the wearer's wrist without the need for any interlocking or intertwined components. This may be accomplished because the form-retaining characteristics of the spring steel helps form the band 200 around the user's wrist. Alternatively, the fastener may be a generic watch band clap wherein holes are created near the end of the band 200 and a pin through the hole is utilized to secure the band strap around the wearer's wrist. However, as would be understood by those of skill in the art, holes in the battery of the band or strap will reduce the battery life and likely make manufacturing more difficult. Consequently, the preferred method of clasp would be a buckle, ratchet, magnetic or similar clasp or a clasp-less band 230, none of which require holes in the band or strap.

Turning now to FIG. 2(b), a more detailed view of the strap or band 200 is illustrated. As previously discussed, the strap or band 200 is comprised of numerous layers. The first layer is the spring steel layer 235, which is comprised of a spring steel frame disposed along at least a portion of the length of the strap or band 200. While spring steel is disclosed in this embodiment, it should be understood that any material capable of supporting the structure of the band and battery, while allowing for flexibility, is suitable. The spring steel 235 may be adhesively coupled to a battery layer 240 using double sided tape or any other adhesive sufficient to permanently attach the battery layer 240 to the spring steel layer 235. The battery layer 240 may be comprised of a Flexible Lithium-Ceramic Battery (FLCB). FLCBs are particularly advantageous because they are very thin, flexible, light, and intrinsically safe relative to other types of batteries. Despite these advantages, other types of batteries may be suitable for use with the present invention, such as other types of lithium ion-batteries (e.g., lithium polymer battery). The battery layer 240 and the spring steel layer 235 are interposed between a fashion layer 225, which as previously discussed may be made of leather or another material. While leather may be particularly desired by a wearer because of its durability, softness and added comfort, other materials, such as steel and the like, may be used for the outer surface, so long as the material is applied in such a way that the battery layer 240 and spring steel layer 235 are insulated from water or liquid damage. This may require overmolding the spring steel layer 235 and battery layer 240, before applying the outer most layer (e.g., a steel-link band). While not expressly shown in FIGS. 2(a)-(b), the fashion layer 225 may contain a hole where the watch dock 205 is placed, and instead an injection molded or low pressure molded material (e.g., polyamide, polyolefin) may occupy that hole in the fashion layer 225 to create a water resistant seal where the dock 205 is secured to the band 200. Alternatively, the watch dock 205 may fully integrated into the band 200 such that the dock 205 actually forms a water seal with the band. This may be accomplished by, for example, overmolding the dock 205 onto the band.

Turning now to FIGS. 2(c)-(d), a top and isometric view of the watch dock 205 of the strap or band 200 is shown. The dock 205 may include pins 245 or another form of interface to connect the top surface of the watch dock 215 and the band circuitry to the external circuitry (not shown). Additionally, the watch dock 205 may include charging circuitry on the back surface 210 so that the battery layer 240 may be charged even when the watch circuitry is not interfaced with the watch dock 205. When the watch dock 205 is not fully integrated into the band 200, the dock 205 can be secured to the strap or band 200 any number of ways known in the art, including but not limited to attaching the dock 205 to the band 200 by: (1) snap fitting; (2) screws; (3) adhesive bonding; or (4) double sided tape.

The process for creating the strap or band 200 from FIGS. 2(a)-(d) is described in further detail in the manufacturing process 300 shown in FIG. 3. It should be noted initially that the method 300 is a simplified flowchart to represent useful processes but does not limit the sequence in which the functions take place.

As shown, the manufacturing process 300 starts at 305 typically with the forming of the spring steel frame 235 into the desired shape. As previously discussed, spring steel is very flexible but will typically return to its original form. Therefore, the spring steel frame 235 must be initially formed into the desired shape prior to implementing it into the strap or band 200. As would be understood by those having ordinary skill in the art, because spring steel always attempts to revert to its original form, it may be necessary to form the spring steel frame 235 for an intended wearer's wrist size (e.g. “large wrist size,” “medium wrist size”). Next, at 310 the adhesive layer (not shown) is applied to the spring steel frame 235. At 315, the battery layer 240 is secured to the spring steel frame 235 using the adhesive layer. Finally, at 320 the assembly of the battery layer 240, adhesive layer, and spring steel frame 235 are covered with a fashion layer 225. As previously discussed, the fashion layer 225 may also be comprised of a harder material, such as stainless steel. Such materials may be desirable by some wearers because of the more expensive appearance of the material. Regardless of which material is used, the material is preferably water-resistant in order to protect the battery layer 240 from liquid damage.

While not expressly illustrated in the manufacturing process 300, a hole may be left in the top center portion of the fashion layer 225 of the strap or band 200 when applying the fashion layer 225 at step 320. Thermoplastic polyurethane (TPU), or a similar material, may then be injection molded, or a hard material may be low pressure molded, over the exposed center portion to form a water-resistant seal where the dock 205 is secured to the band 200. The dock 205 may then be secured to the center portion of the band 200 using any number of methods known in the art, some of which previously discussed. Alternatively, the dock 205 may be fully integrated into the band 200 by overmolding the dock 205 to the band 200. Preferably the dock 205 is formed in a manner that creates a water resistant seal between the dock 205 and the band 200 so that liquids may not seep through the points where the housing of the dock 205 and band 200 connect.

Turning now to FIGS. 4(a), an exemplary strap or band 400 is shown, which is comprised of an injection molded sub structure secured to a battery. Just as with the embodiment of FIGS. 2-3, the strap or band 400 may be coupled to a watch dock 405. The dock 405 maybe secured to the strap or band 400 any number of ways known in the art, some of which were discussed in reference to the embodiment of FIGS. 2-3. The top surface 415 of the watch dock 405 is designed to interface with external watch circuitry (e.g., the watch face and its corresponding circuitry). This may be accomplished by including interface pins on the top surface 415. A user may then insert the external circuitry into the watch dock 405 by snapping the external circuitry housing in place such that the pins on the top surface 415 engage with an interface on the bottom of the external circuitry housing. Additionally, the band 400 may include a charging connection or interface on the watch dock 405 itself. This may allow the battery in the band 400 to be charged even when the external circuitry is not interfaced with the watch dock 405. Alternatively, the external circuitry may include a charging connection to allow the battery of the band 400 to be charged when the external security is coupled to the dock 405. The strap or band 400 is comprised of an outer surface layer 425, which may be comprised of an overmolded material or leather or another soft material. Alternatively, the outer surface layer 425 may be made of a harder material, such as steel. The outer layer could be, for example, a segmented metal or chain-link, which may be more visually appealing to the wearer. Interposed between the outer layer 425 may be a layer 420 comprising a battery and an injection molded sub structure or frame. The strap or band 400 also contains a fastener 430, which allows for the wearer of the strap or band 400 to close the band or strap around his or her wrist. The fastener 430 may be designed like the fastener 230 from FIGS. 2(a)-(d). As illustrated in FIGS. 4(a)-(d), the fastener 430 (i.e., a ratchet-like clasp) may be designed to allow the user to close the band or strap 400 without the need for holes in the strap or band 400. As will be appreciated by those of ordinary skill in the art, this may be especially advantageous because, as previously discussed; inserting a hole into the battery may reduce its storage capacity and make manufacturing of the battery more difficult. The fastener 430 may also be designed such that the wearer can tighten the band without applying so much pressure on the battery that it becomes worn or damaged.

Turning now to FIG. 4(b), a more detailed view of the strap or band 400 is illustrated. As previously discussed, the strap or band 400 is comprised of numerous layers. The first layer is the injection molded sub structure 435, which may be any suitable polymer, including thermoplastics, thermosets, and certain elastomers. The sub structure 435 may be secured to a battery layer 440 using double sided tape or another adhesive sufficient to permanently attach the battery layer 440 to the sub structure 435. As previously explained with regard to the first disclosed embodiment, the battery layer 440 is preferably comprised of a Flexible Lithium-Ceramic Battery (FLCB), but other types of batteries may be suitable for use with the present invention, including but not limited to other types of lithium ion-batteries (e.g., lithium polymer batteries). The sub structure 435 and the battery layer 440 are then interposed between an overmolded layer 425, which may be comprised of a rubber or plastic material. Alternatively, the overmolded layer 425 may be instead replaced with a fashion layer such as the fashion layer 225 from FIGS. 2(a)-(d). In some cases, it may be necessary to add a fashion layer over the overmolded layer 425 in order to protect the battery from liquids, dust, and the like. While not expressly shown in FIGS. 4(a)-(b), the overmolded layer 425 may contain a hole where the dock 405 is placed, and instead an injection molded or low pressure molded material (e.g., polyamide, polyolefin) may occupy that hole to create a water resistant seal where the dock 405 is secured to the band 400. Alternatively, the dock 405 may be overmolded or otherwise fully integrated into the band 400 such that the dock 405 actually forms a water seal with the band.

Turning now to FIGS. 4(c)-(d), a top and isometric view of the dock 405 of the strap or band 400 is shown. As previously discussed, the dock 405 may include pins (not shown) or another form of interface on the top surface 415 of the dock 405 to connect the external circuitry to the battery layer 440 of the strap or band 400. Additionally, the dock 405 may include charging circuitry on the back or bottom surface 410 so that the battery layer 440 may be charged even when the external circuitry is not interfaced with the strap or band 400.

The process for creating the strap or band 400 from FIGS. 4(a)-(d) is described in further detail in the manufacturing process 500 shown in FIG. 5. It should be noted initially that the method 500 is a simplified flowchart to represent useful processes but does not limit the sequence in which the functions take place.

As shown, the manufacturing process 500 starts at 505 typically with the forming of the sub structure 435 by injection molding, which would generally be performed using a polymer, but may alternatively include a metal (e.g., steel). Because the sub structure 435 is injection molded, it may be less flexible than a band or strap that utilizes spring steel as the base structure. Next, at 510 the adhesive layer (not shown) is applied to the sub structure 435. At 515, the battery layer 440 is secured to the sub structure 435 using an adhesive, such as double-sided tape. Finally, at 520 the assembly of the battery layer 440, adhesive layer, and sub structure 435 are covered with an overmolded layer 425. Alternatively, the assembly may be covered with steel, leather, or another material (i.e., a fashion layer) instead of the overmolded layer 425. If it is desired to use a chain-link type material (or any material that has openings) as the overmolded layer 425, it may be necessary to first overmold the adhesively coupled battery layer 440 and sub structure 435 layer before applying the chain-link material (i.e., a fashion layer). This may ensure that the battery layer 440 is protected from water or other liquids. Regardless of which material is used, preferably the material is water-resistant in order to protect the battery layer 440 from liquid damage.

While not expressly illustrated in the manufacturing process 500, a hole may be left in the top center of a portion of the overmolded layer 425 of the strap or band 400. Thermoplastic polyurethane (TPU) may then be injection molded or a hard material may be low pressure molded over the exposed center portion to form a water-resistant seal where the watch dock 405 is secured to the band 400. The dock 405 would then be secured to the center portion of the band 400 using any number of ways known in the art, which were previously discussed. Alternatively, also as previously discussed, the dock 405 may be fully integrated into the band 400 by overmolding the dock 405 to the band 400.

Additionally, a fastener 430 may be attached to one end of the strap or band 400. The fastener 430 may be designed to allow one end of the strap or band 400 to clamp to the opposing end of the strap or band 400 without the need for holes in the band.

As would be understood by those having ordinary skill in the art, the presently disclosed invention may be utilized with any polymer or other material (e.g., a metal) suitable to achieve the objectives of a flexible band or strap integrated with a battery. Moreover, while adhesives are described as securing the battery to spring steel or injection molded frame or structure, those of skill in the art would recognize that any method of securing the battery to another structure may be used to implement the disclosed invention. Further, while certain embodiments may be described as being water-resistant, it would be understood that the present embodiments could be implemented without such a feature. For instance, the battery itself could be manufactured to be integral with the spring steel as well making one layer that could be covered as described herein by a fashion layer.

It will also be understood that the above description is intended to be illustrative, and not restrictive. For example, the above-described embodiments may be used in combination with each other and features of one embodiment may be utilized with other embodiments. Many other embodiments will be apparent to those of ordinary skill in the art upon reviewing the above description. For example, the strap or band may be implemented in other wearable technologies other than watches, such as wearable necklaces, ear rings, etc. The scope of the invention should, therefore, be determined with reference to the appended claims, along with the frill scope of equivalents to which such claims are entitled. In the appended claims, the terms “including” and “in which” are used as the plain-English equivalents of the respective terms “comprising” and “wherein.” Moreover, while specific types of batteries, plastics, etc. have been mentioned throughout this specification, it would be understood that any known battery, plastic, etc. may be suitable for use with the presently disclosed invention.

1. An apparatus comprising:
a first layer comprising a structural support frame, wherein the structural support frame provides an original shape and form to the apparatus, wherein the apparatus: (1) retains a new shape and form when physical force is applied to the apparatus by a wearer of the apparatus; and (2) returns to the original shape and form when physical force is no longer applied to the apparatus by the wearer;
a second layer comprising a battery;
a third layer that forms an exterior portion of the apparatus, wherein the first and second layers are interposed within the third layer, wherein the second layer is disposed along at least a third of the length of the third layer;
a housing that forms an exterior portion of the apparatus, wherein the housing provides a path for the battery to provide power to circuitry connected to the housing; and
a charging interface connected to the battery layer, wherein the interface provides an electrical conduit for charging the battery.

2. The apparatus of claim 1, wherein the structural support frame comprises a spring steel frame.

3. The apparatus of claim 2, wherein the battery comprises a flexible lithium-ceramic battery.

4. The apparatus of claim 1, wherein the battery comprises a flexible lithium-ceramic battery.

5. The apparatus of claim 4, wherein the structural support frame comprises spring steel frame.

6. The apparatus of claim 5, wherein the first layer is attached to the second layer using adhesive bonding or double sided tape.

7. The apparatus of claim 5, wherein a water resistant seal is formed around the second layer.

8. The apparatus of claim 7, wherein at least a part of the water resistant seal is formed by overmolding over the second layer.

9. The apparatus of claim 8, wherein at least a part of the water resistant seal is formed by the housing.

10. The apparatus of claim 9, wherein the interface is a part of the housing.

11. The apparatus of claim 10, wherein there are no holes through the second layer.

12. The apparatus of claim 6, wherein the third layer is overmolded over the second layer to render the second layer water-resistant.

13. The apparatus of claim 4, wherein the structural support frame is a polymer.

14. A method of assembling an apparatus comprising:
attaching a first layer to a second layer, wherein the first layer comprises a structural support frame and the second layer comprises a battery,
wherein the structural support frame provides an original shape and form to the apparatus, wherein the apparatus: (1) retains a new shape and form when physical force is applied to the apparatus by a wearer of the apparatus; and (2) returns to the original shape and form when physical force is no longer applied to the apparatus by the wearer;
disposing the first and second layers within a third layer, wherein the third layer forms an exterior portion of the apparatus and the second layer is disposed along at least a third of the length of the third layer;
attaching a housing to at least one of the layers so that the housing forms an exterior portion of the apparatus, wherein the housing provides a path to allow the battery to provide power to circuitry connected to the housing; and
attaching a charging interface as part of the apparatus, wherein the interface provides an electrical conduit to charge the battery.

15. The method of claim 14, wherein the structural support frame comprises a spring steel frame.

16. The method of claim 15, wherein the battery comprises a flexible lithium-ceramic battery.

17. The method of claim 14, wherein the battery comprises a flexible lithium-ceramic battery.

18. The method of claim 17, wherein the structural support frame comprises spring steel frame.

19. The method of claim 18, further comprising attaching the first and second layers using adhesive bonding or double sided tape.

20. The method of claim 18, further comprising forming a water resistant seal around the second layer.

21. The method of claim 20, further comprising forming at least part of the water resistant seal by overmolding over the second layer.

22. The method of claim 21, further comprising forming at least part of the water resistant seal by overmolding the housing.

23. The method of claim 18, wherein the interface is a part of the housing.

24. The method of claim 18, wherein there are no holes through the second layer.

25. The method of claim 18, further comprising overmolding the third layer over the second layer to render the second layer water-resistant.

26. The method of claim 17, wherein the structural support frame comprises a polymer.
